(19) United States
(12) Patent Application Publication
(10) Pub. No.: US 2019/0259098 A1
(43) Pub. Date: Aug. 22, 2019

(54) A METHOD AND AN APPARATUS FOR ALLOCATING A PLURALITY OF CREDIT LIMITS AND USE THEREOF

(71) Applicant: MASTERCARD INTERNATIONAL INCORPORATED, PURCHASE, NY (US)

(72) Inventor: Arunmurthy Gurunathan, Pune (IN)

(21) Appl. No.: 16/346,400

(22) PCT Filed: Oct. 9, 2017
(86) PCT No.: PCT/US2017/055724

§ 371 Date: Apr. 30, 2019

(30) Foreign Application Priority Data
Nov. 24, 2016 (SG) 10201609889V

(51) Int. Cl. G06Q 40/02; G06Q 20/24; G06Q 20/40

(52) U.S. Cl. CPC G06Q 40/025; G06Q 20/24; G06Q 20/4093; G06Q 20/4037; G06Q 20/405

(57) ABSTRACT

Disclosed in a computer-implemented method for allocating a plurality of credit limits for a payer account associated with a single payment card. The method includes receiving, at a server, a request message to allocate at least a second one of the plurality of credit limits for the payer account, each of the plurality of credit limits being a maximum payment amount that is authorised for payment to a category of transaction; and allocating the second one of the plurality of credit limits to the single payment card.

### CROSS-REFERENCE TO RELATED APPLICATION

This application claims the benefit of, and priority to, Singapore Patent Application No. 10201609889V filed on Nov. 24, 2016. The entire disclosure of the above application is incorporated herein by reference.

### TECHNICAL FIELD

The present disclosure relates to a method and an apparatus for allocating a plurality of credit limits and use thereof. More specifically, the present disclosure relates to a method and an apparatus for allocating and using a plurality of credit limits for a payer account associated with a single payment card for effecting a transaction.

### BACKGROUND

Rapid economic development has given rise to different forms of financial instruments for performing day-to-day transactions. It is increasingly common for individuals to hold multiple financial products or to avail themselves of various financial services such as a payment card, a loan, a credit line or an insurance policy. However, these different financial vehicles are often disjointed. That is, each of these financial instruments is often separately linked to a unique individual account. As a result, customers and financial institutions spend time and resources managing these separate accounts, which consume unnecessary costs and energy.

It is also difficult for customers to keep track of the different credit limits associated with their financial products or services and the various processes for accessing that credit. In the case of a medical insurance policy, for example, where an individual will generally have to pay upfront for a medical bill using the a personal credit card account before seeking reimbursement from the insurance company, the individual is often required to follow up on the administration of claiming the payment, and to spend time managing the insurance account to keep track of the amount of insurance limit used or remaining.

Presently, to provide a better user experience to customers with multiple accounts, financial institutions have generally developed a common platform that displays multiple accounts on a single page. For example, a customer with access to an internet bank account may be able to manage all his or her different related accounts in a single view. Alternatively, a payment card issued by financial institutions may also provide access to different related accounts via the payment card. For example, a credit card which is linked to a credit card account may also double up as a debit card that is linked to a separate debit account, and a transport payment card that is linked to a separate transportation payment account. Nevertheless, all these methods merely provide ways to increase accessibility of these separate accounts. The fundamental issues of having distinct accounts, where each separate account requires additional resources and manpower to maintain and update, remain unaddressed.

In view of the above, it would be desirable to provide a method and an apparatus allowing a payer to access the different financial tools which overcomes one or more of the above disadvantages or at least provides a useful alternative. It would also be desirable for the method and apparatus to allow effective management of all transactions related to the account and provide cost reduction due to transaction process simplification.

### SUMMARY

The present disclosure provides a computer-implemented method for allocating a plurality of credit limits for a payer account associated with a single payment card, the method comprising:
receiving, at a server, a request message to allocate at least a second one of the plurality of credit limits for the payer account, each of the plurality of credit limits being a maximum payment amount that is authorised for payment to a category of transaction; and
allocating the second one of the plurality of credit limits to the single payment card.

The present disclosure also provides a method of effecting a transaction based on the method described above, the method comprising:
receiving, at the server, a transaction request, the transaction request including the category of transaction and a transaction amount, the transaction amount being an amount to be paid by the payer account in the transaction;
determining, at the server, at least one of the plurality of credit limits to be used in effecting the transaction based on the category of transaction; and
effecting, at the server, the transaction.

The present disclosure still further provides an apparatus for allocating a plurality of credit limits for a payer account associated with a payment card, the apparatus comprising:
at least one processor; and
at least one memory including computer program code;
the at least one memory and the computer program code configured to, with at least one processor, cause the apparatus at least to:
receive a request message to allocate at least a second one of the plurality of credit limits for the payer account, the request message including data relating to the payer account, each of the plurality of credit limits being a maximum payment amount that is authorised for payment to a category of transaction; and
allocate the second one of the plurality of credit limits.

The present disclosure also provides an apparatus for effecting a transaction based on the apparatus described above, the apparatus comprising:
at least one processor; and
at least one memory including computer program code;
the at least one memory and the computer program code configured to, with at least one processor, cause the apparatus at least to:
   receive a transaction request, the transaction request including the category of transaction and a transaction amount, the transaction amount being an amount to be paid by the payer account in the transaction;
   determine at least one of the plurality of credit limits to be used in effecting the transaction based on the category of transaction; and
   effect the transaction.

The present disclosure yet further provides a computer-readable storage medium having stored thereon computer program code which when executed by a computer causes the computer to execute a method as described above.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments, by way of example only, and to explain various principles and advantages in accordance with a present embodiment.

FIG. 1 depicts a block diagram of a system for allocating and using a plurality of credit limits for a payer account associated with a single payment card for affecting a transaction in accordance with a first embodiment.

FIG. 2 depicts a flow chart of steps in the method of allocating a plurality of credit limits for a payer account associated with a single payment card for effecting a transaction in accordance with the first embodiment, comprising the steps of receiving a request message to allocate at least a second one of the plurality of credit limits, and allocating the at least a second one of the plurality of credit limits.

FIG. 3 depicts a flow chart of steps in the method of effecting a transaction based on the method of allocating a plurality of credit limits for a payer account associated with a single payment card for effecting a transaction in accordance with the first embodiment, comprising the steps of receiving a transaction request, determining at least one of the plurality of credit limits to be used, and effecting the transaction.

FIG. 4, comprising FIG. 4A, FIG. 4B, FIG. 4C and FIG. 4D, depicts additional steps in the method for allocating at least a second one of a plurality of credit limits for a payer account associated with a single payment card in accordance with other embodiments, where FIG. 4A depicts the step of 204 of FIG. 2 further comprising authenticating the request message 120, and allocating the second one of the plurality of credit limits to the single payment card; FIG. 4B depicts the step of 202 of FIG. 2 further comprising sending a response message 122 which includes a request for an amount to be allocated for the second one of the plurality of credit limits, and receiving a reply 124 to the response message 122 indicating the amount to be allocated for the second one of the plurality of credit limits; FIG. 4C depicts the step of 202 of FIG. 2 further comprising validating historical transaction data, and the step of 204 of FIG. 2 further comprising receiving the at least a second one of the plurality of credit limits to be allocated and allocating the second one of the plurality of credit limits to the single payment card; and FIG. 4D depicts the step of 202 of FIG. 2 further comprising sending a request message to a third party server 114, and the step of 204 of FIG. 2 further comprising receiving the at least a second one of the plurality of credit limits to be allocated and allocating the second one of the plurality of credit limits to the single payment card.

FIG. 5, comprising FIG. 5A and FIG. 5B, depicts additional steps in the method of using a plurality of credit limits for a payer account associated with a single payment card for effecting a transaction in accordance with other embodiments, wherein FIG. 5A depicts the step of 304 of FIG. 3 further comprising determining at least one of the plurality of credit limits to be used based on any one of the following: payer category code, payee country code, payment card type, pre-determined date or transaction amount range, and processing code associated with payer account type, and determining the at least one of the plurality of credit limits to be used in effecting the transaction; and FIG. 5B depicts the step of 304 of FIG. 3 further comprising determining at least one of the plurality of credit limits to be used based on any one of the following: payee country code, transaction currency code, a billing currency and a total number of the plurality of credit limits, and determining the at least one of the plurality of credit limits to be used in effecting the transaction.

FIG. 6, depicts a flow chart of additional steps in the method of using a plurality of credit limits for a payer account associated with a single payment card for effecting a transaction in accordance with another embodiment, wherein the step 304 of FIG. 3 further comprises determining at least one of the plurality of credit limits to be used, determining if an amount of the at least one of the plurality of credit limits determined to be used in effecting the transaction is less than the transaction amount, and determining another one of the plurality of credit limits if it is determined that the amount of the at least one of the plurality of credit limits determined to be used in effecting the transaction is less than the transaction amount, and wherein the step 306 of FIG. 3 further comprises effecting the transaction using the another one of the plurality of credit limits.

FIG. 7 depicts a schematic diagram of a computer system suitable for use in executing the methods depicted in FIGS. 2 to 6.

FIG. 8 depicts an exemplary computing device to realise a server for the payment network server 106 shown in FIG. 1.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “determining”, “allocating”, “validating”, “assigning”, “receiving”, “identifying”, “sending”, “updating”, “effecting” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Various embodiments relate to a method and an apparatus for allocating at least a second one of a plurality of credit limits for a payer account associated with a single payment card. In an embodiment, at least one of the plurality of credit limits for the payer account associated with a single payment card may be used for effecting a transaction. Each of the plurality of credit limits identifies a maximum payment amount that is authorised for payment to a category of transaction. The maximum payment amount may be a maximum amount for a single transaction or a maximum total amount for all transactions relating to the relevant category of transaction or service—a “service” may be a banking service or product such as a credit facility, debit facility or loan, but may also be a non-banking service such as health insurance, car insurance, home and contents insurance and other services in respect of which a user may claim funds, for example after an accident or other event.

In the following description, a transaction is effected using at least one of a plurality of credit limits of a payer account associated with a single payment card. The at least one of a plurality of credit limits can be allocated by a method comprising receiving, at a server, a request message to allocate the at least a second one of the plurality of credit limits for the payer account, and allocating the second one of the plurality of credit limits. In various embodiments, the second one of the plurality of credit limits may be a credit limit in addition to an existing credit limit of the payer account associated with the single payment card. For example, the payer account associated with the single payment card may have an existing credit limit such as a credit limit associated with a credit line. In various embodiments, the second one of the plurality of credit limits, such as a credit limit associated with a loan or an insurance policy, may be allocated to the payer account on top of the present credit limit associated with the credit line. In various embodiments, the number of credit limits of the payer account associated with the single payment card may be more than two. In various embodiments, the number of credit limits of the payer account associated with the single payment card may be determined by an issuer of the payer account. In various embodiments, the issuer of the payer account may be a bank or a financial institution or a payment network. In various embodiments, at least one of the plurality of credit limits of the payer account can then be used in effecting a transaction. The method of effecting a transaction comprising, receiving, at the server, a transaction request, the transaction request including the category of transaction and a transaction amount, the transaction amount being an amount to be paid by the payer account in the transaction; determining, at the server, at least one of the plurality of credit limits to be used in effecting the transaction based on the category of transaction; and effecting, at the server, the transaction. The at least one of a plurality of credit limits may be associated with a credit line, a debit line, an insurance policy, a loan, or a type of currency. In an embodiment, the transaction is a payment transaction. In other words, effecting the transaction involves a payment between parties to the transaction. The parties to the transaction generally includes a payer and a payee. In embodiments, the payer can be a customer and a payee can be a merchant. The method and the apparatus for allocating the second one of the plurality of credit limits for the payer account associated with the single payment card and effecting a transaction using at least one of the plurality of credit limits advantageously consolidate the plurality of credit limits under the single payment card and allows ease of management of all transactions related to different credit limits associated with, for example, loans, insurance policies and credit/debit facilities. Moreover, the method and the apparatus also facilitates easy processing for issuers of the payer account, since all transactions are consolidated to the single payment card associated with the payer account, and provide cost reduction due to process simplification.

Use of the funds associated with one credit limit may not affect the amount of funds available under another credit limit. For example, making a payment using funds from an insurer will not affect the credit limit and funds available through a credit facility with an acquiring bank. The total credit available using the payment card may thus be the sum total of credit limits for services accessible using that card.

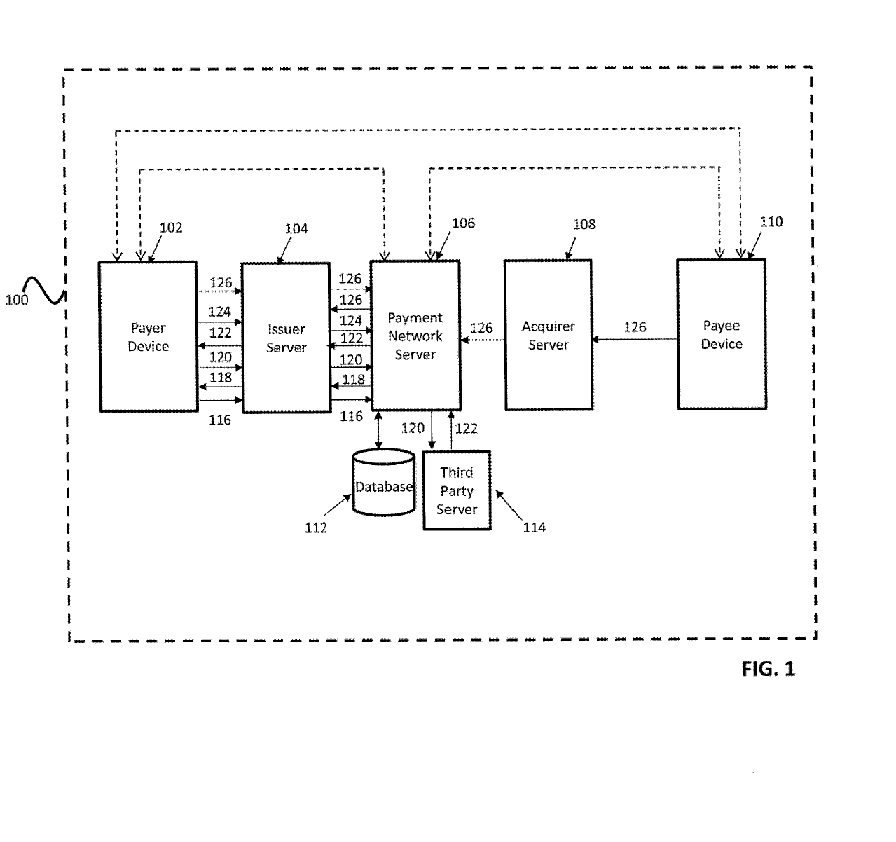

FIG. 1 illustrates a block diagram of a system 100 within which data from the payer and payee can be received and processed.

The system 100 comprises a payer device 102 in communication with an issuer server 104. The payer device 102 may also be in direct communication with a payment network server 106, without having to communicate with the issuer server 104. In specific embodiments, the payer device 102 may also be in direct communication with a payee device 110, without having to communicate with the issuer server 104 or the payment network server 106.

In the system 100, the issuer server 104 is in communication with the payment network server 106. The payment network server 106, in turn, is in communication with an acquirer server 108. The acquirer server 108, in turn, is in communication with the payee device 110. In specific embodiments, the payment network server 106 may also be in direct communication with the payee device 110.

Use of the term ‘server’ herein can mean a single computing device or a plurality of interconnected computing devices which operate together to perform a particular function. That is, the server may be contained within a single hardware unit or be distributed among several or many different hardware units.

The payer device 102 typically is associated with a payer/customer who is a party to a transaction that occurs between the payer device 102 and the payee device 110 through a transaction. In particular, the payer/customer may have a payer account which is associated with a single payment card. In various embodiments, the payer account may be associated with a plurality of credit limits. In various embodiments, the single payment card associated with the payer account may be associated with a plurality of credit limits. At least one of the plurality of credit limits may be used in a payment transaction. The payer device 102 may be a fixed (wired) computing device or a wireless (portable) computing device. In specific implementations, the payer device 102 may be a handheld or portable or mobile device carried or used by the customer, or may refer to other types of electronic devices such as a personal computer, a land-line telephone or an interactive voice response (WR) system and the like. The mobile device may be a device, such as a mobile phone, a laptop computer, a personal digital computer (PDA), a mobile computer, a portable music player (such as an iPod™ and the like).

The issuer server 104 generally is associated with an issuer and may include one or more computing devices that are used to perform a payment transaction. The issuer may be an entity (e.g. a company or organization, such as a bank, a mobile network operator or a retailer) which issues (e.g. establishes, manages, administers) a transaction credential or an account (e.g. a financial bank account). An account, which may also be termed as a payer account, may be associated with a plurality of payer devices 102. In various embodiments, the payer account is allocated with a plurality of credit limits where at least one of the plurality of credit limits may be used in effecting a transaction.

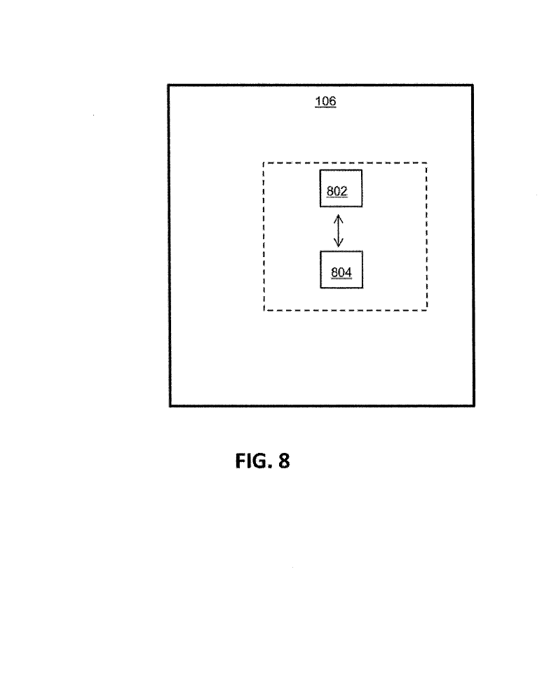

The payment network server 106 typically is associated with a payment network. For example, the payment network server 106 may be part of the Banknet® network operated by MasterCard®. The payment network (e.g. MasterCard®) operates to process transactions, clear and settle funds for payments between two entities (e.g. two banks). The payment network server 106 may include one or more computing devices that are used for processing transactions. An exemplary payment network server 106 is shown in FIG. 8.

The acquirer server 108 generally is associated with an acquirer who may be an entity (e.g. a company or organization) which issues (e.g. establishes, manages, administers) a transaction credential or an account (e.g. a financial bank account) of the payee/merchant. An account of the payee/merchant may also be known as a payee account. Examples of the acquirer include a bank and/or other financial institution. As stated in the above, the acquirer server 108 may include one or more computing devices that are used to establish communication with another server by exchanging messages with and/or passing information to the other server.

The payee device 110 typically is associated with a payee/merchant who is also a party to the transaction that occurs between the payer device 102 and the payee device 110 through the transaction. In an embodiment, the payee device 110 may also be associated with any one party who has an arrangement with the payer to execute a transaction between them. The payee device 110 may be a point-of-sale (POS) terminal, an automatic teller machine (ATM), a personal computer, a computer server (hosting a website, for example), an WR system, a land-line telephone, or any type of mobile device such as a mobile phone, a personal digital assistant (PDA), a laptop computer, a tablet computer and the like.

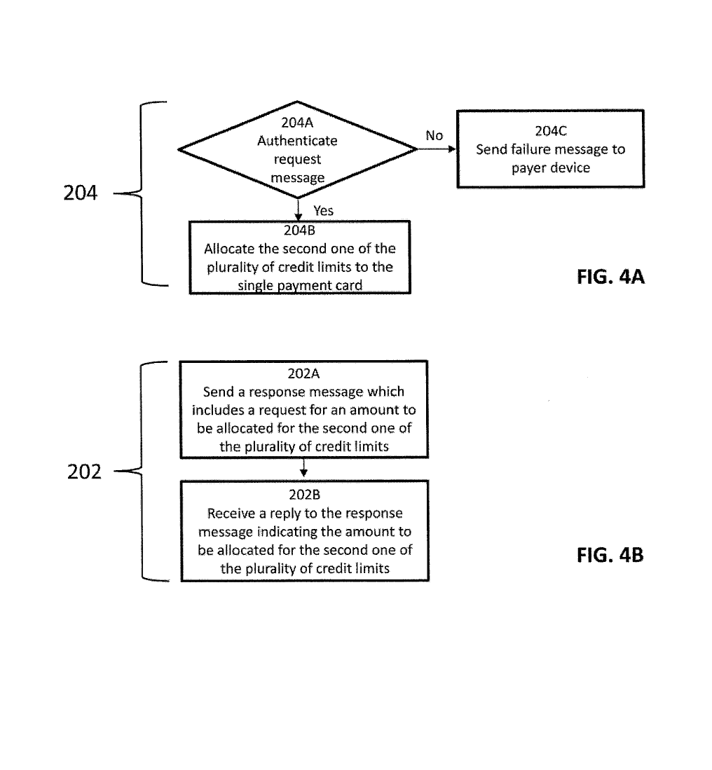

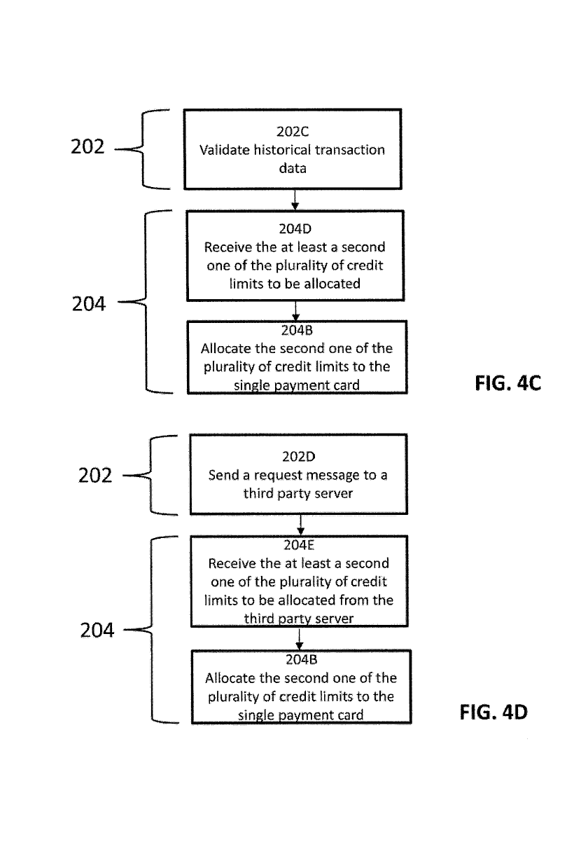

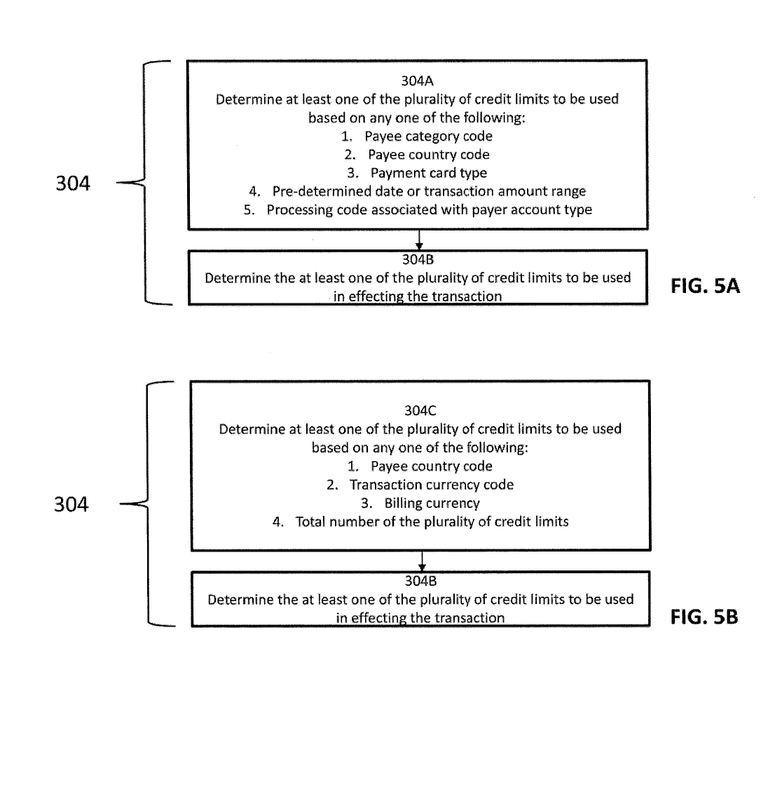

The payment network server 106 may be configured to communicate with, or may include, a database (or a transaction database) 112. The transaction database 112 stores data corresponding to a transaction (or transaction data). Examples of the data include Transaction ID, Payee ID, Payer Name, Payee Name, Payee Country, Payee Address, Payee Postal Code, Payee Category Code, Payee Country Code, Payment Card Type, Predetermined Date and Transaction Amount Range, Processing Code with the Payer Account Type, Transaction Currency Code, Billing Currency and Total Number of Credit Limits. For example, data (“Payee name” or “Payee ID”) relating to the payee, time and date for which the goods/services relating to the transaction will be delivered are included in the database 112. In some embodiments, the data also include payer data which identify a payer account and payee data which identify a payee account. In some embodiments, the payer account and the payee account are associated with corresponding accounts in the issuer server and the acquirer server respectively. In some embodiments, the data also comprise historical transaction data of the payer. In various embodiments, the historical transaction data of the payer includes past transactions carried out by the payer using the payer account, past payment records and usage of the payer account associated with the payment card. Further details on how these data are utilised and managed are described in FIGS. 4 and 5.

In various embodiments, the payment network server 106 may also be configured to communicate with a third party server 114. The third party server 114 may be associated with a financial institution or an insurance company that administers insurance policy.

In a preferred embodiment, the payer device 102 is capable of wireless communication using a suitable protocol with the issuer server 104. In some embodiments, the wireless communication comprises established telecommunication known in the art such as GSM, CDMA, WIFI or the like. In some embodiments, the wireless communication is established through the Internet via a website associated with the issuer server 104. In another embodiment, the payer device 102 is capable of wireless communication using a suitable protocol with the payee device 110. For example, embodiments may be implemented using payer devices 102 that are capable of communicating with WiFi/Bluetooth-enabled payee devices 110. It will be appreciated by a person skilled in the art that depending on the wireless communication protocol used, appropriate handshaking procedures may need to be carried out to establish communication between the payer device 102 and the payee device 110. For example, in the case of Bluetooth communication, discovery and pairing of the payer device 102 and the payee device 110 may be carried out to establish communication.

In an example, in allocating at least a second one of a plurality of credit limits for a payer account associated with a single payment card, an enrolment request message 116 is sent to the issuer server 104, as a request to allow the payer account to be allocated a plurality of credit limits. The enrolment request message 116 generated by the payer device 102 may be communicated to the payment network server 106 via the issuer server 104. In another embodiment, the enrolment request message 116 may be communicated directly to the payment network server 106, without communicating the enrolment request message 116, via the issuer server 104. In some embodiments, the enrolment request message 116 may be communicated by any means known to a person skilled in the art, for example, wireless communications such as NFC, WIFI, Bluetooth, the public Internet or any other form of viable means of data communications. In various embodiments, the request to allow the payer account to be allocated a plurality of credit limits maybe a one-off request. That is, the payer/customer may only need to send a request to get an approval for the payer account to be allocated a plurality of credit limits once. The plurality of credit limits may be associated with the payer account or the payment card corresponding to the payer account. In various embodiments, each of the plurality of credit limits corresponds to a maximum payment amount that is authorised for payment to a category of transaction. In some embodiments, the payer account may be issued by an issuer, such as a bank or a financial institution, and is maintained at an issuer server 104 associated with the issuer. Alternatively, the payer account may be issued by a payment network associated with a payment network server 106. In various embodiments, the payer account may be associated with a single payment card. In some embodiments, the plurality of credit limits may be associated with the single payment card associated with the payer account. In other embodiments, the payer account may be associated with a plurality payment cards. Each of the plurality of payment cards may in turn be associated with a plurality of credit limits. In some embodiments, the payer account is to be allocated a plurality of credit limits if it is determined that an amount in the payer account is at least equal to or more than a predetermined threshold value. The predetermined threshold value is a pre-set value used to determine, for example, if the payer account is associated with a high-profile or high-value payer/customer. In other words, it may be determined that a payer account is allowed to be allocated with a plurality of credit limits only if it is associated with a payer with large assets. The predetermined threshold value may be determined by the issuer server 104 or the payment network server 106. In various embodiments, the identified high-profile or high-value payer/customer has a higher credit limit that can over arch a traditional purchase limit, the higher credit limit may cover up to 30 to 40 percent of a plurality of credit limits including credit limits associated with medical and/or vehicle insurance policies and credit limits associated with personal loans, car loans and/or housing loans.

In various embodiments, in allocating at least a second one of a plurality of credit limits for the payer account associated with the single payment card, an enrolment response message 118 is received from the issuer server 104. This can, for example, be generated by the issuer server 104 in response to the enrolment request message 116. The enrolment response message 118 may include an approval for the payer account to be allocated a plurality of credit limits. In various embodiments, the approval for the payer account to be allocated a plurality of credit limits maybe a one-off approval. That is, the approval for the payer account to be allocated a plurality of credit limits may only need to be granted once. In an embodiment, the enrolment response message 118 may be generated by the issuer server 104. In another embodiment, where the payer account is issued directly by the payment network associated with the payment network server 106, the enrolment response message 118 may be generated by the payment network server 106. In some embodiments, the enrolment response message 118 may be communicated directly to the payer/customer associated with the payer device 102 without communicating via the issuer server 104. In some embodiments, the enrolment response message 118 may be communicated by any means known to a person skilled in the art, for example, wireless communications such as NFC, WIFI, Bluetooth, the public Internet or any other form of viable means of data communications.

In an example, after the payer account has been allowed to be allocated a plurality of credit limits, a request message 120 is sent to the issuer server 104 to allocate at least a second one of the plurality of credit limits for the payer account, where the request message 120 further includes data relating to the payer account. In various embodiments, after the request message 120 is received, it will be authenticated based on the data included in the request message to determine if the second one of the plurality of credit limits is to be allocated. The request message 120 may be authenticated either at the issuer server 104 or the payment network server 106. In some embodiments, one of the plurality of credit limits maybe a credit limit associated with a credit card, a debit card or a charge card. In other embodiments, the second one of the plurality of credit limits may be a credit limit associated with a loan or an insurance policy. There is no particular order in which the credit limit is to be allocated so that a credit limit associated with a loan or an insurance policy may also be a first one of the plurality of credit limits. In embodiments, the loan may be issued by the issuer server 104 or the payment network server 106. In various embodiments, depending on which entity issued the loan, historical transaction data associated with the payer account may be validated either at the issuer server 104 or the payment network server 106 to determine if a credit limit for the loan is to be allocated. In various embodiments, the historical transaction data include information relating to transactions that have been completed using the payer account. After the historical transaction data have been validated and it is determined that the credit limit for the loan is to be allocated, an amount to be allocated for the credit limit for the loan is received at the payment network server 106. In various embodiments, a credit limit associated with the payer account for an insurance policy may also be allocated. This may be achieved by sending the request message 120 from the payment network server 106 to a third party server 114, where the third party server 114 is a server that is associated with an insurance company which administers the insurance policy. The third party server 114 determines if the credit limit associated with the insurance policy is to be allocated. In various embodiments, the third party server 114 determines if a credit limit associated with an insurance policy is to be allocated based on the data relating to the payer account which is comprised in the request message 120. In various embodiments, the data relating to the payer account may include biometric details of the payer/customer and other relevant information pertaining to the type of insurance policy the credit limit is to be associated with. For example, a request message 120 to request a credit limit associated with a car insurance policy to be allocated may include at least data relating to a driving experience of the payer/customer and the make of the car. In various embodiments, the request message 120 generated by the payer device 102 may be communicated to the payment network server 106 via the issuer server 104. In another embodiment, the request message 120 may be communicated directly to the payment network server 106, without communicating the request message 120, via the issuer server 104. In some embodiments, the request message 120 may be communicated by any means known to a person skilled in the art, for example wireless communications such as NFC, WIFI, Bluetooth, the public Internet or any other form of viable means of data communications.

In various embodiments, in allocating at least a second one of a plurality of credit limits for a payer account associated with a single payment card, a response message 122 is received at the payer device 102. The response message 122 can, for example, be generated by the issuer server 104 in response to the request message 116. The response message 122 may include a request for the amount to be allocated to the second one of the plurality of credit limits. In various embodiments, the response message 122 may include a notification that the request message 120 has been processed and that the second one of the plurality of credit limits has been allocated to the single payment card. In another embodiment, where the payer account is issued directly by a payment network associated with the payment network server 106, the response message 122 may be generated by the payment network server 106. In various embodiments, the response message 122 may be communicated to the payer device 102 from the payment network server 106 via the issuer server 104. In other embodiments, the response message 122 may be communicated directly to the payer/customer via the payer device 102 without communicating the response message 122 via the issuer server 104. In various embodiments, for a credit limit which is associated with an insurance policy, the response message 122 may be generated by the third party server 114. In various embodiments, the third party server 114 may be configured to determine if the credit limit of the insurance policy is to be allocated based on the data relating to the payer account comprised in the request message 120. The response message 122 from the third party server 114 may include an amount to be allocated for the credit limit of the insurance policy if it is determined that the credit limit of the insurance policy is to be allocated. In some embodiments, the payment network server 106 or the issuer server 104 may be given a set of predetermined rules by the third party server 114 which may be used to approve the credit limit associated with the insurance policy. In various embodiments, the amount to be allocated to the credit limit associated with the insurance policy may also be predetermined. This may for example be applied to credit limits associated with standard travel and car insurance policies. In various embodiments, the response message 122 may be communicated to the payer device 102 from the third party server 114 via the payment network server 106 and the issuer server 104. In other embodiments, the response message 122 may be communicated from the third party server 114 to the payer device 102 via the payment network server 106 without communicating the response message 122 via the issuer server 104. In some embodiments, the response message 122 may be communicated by any means known to a person skilled in the art, for example wireless communications such as NFC, WIFI, Bluetooth, the public Internet or any other form of viable means of data communications.

In an example, in allocating at least a second one of a plurality of credit limits for a payer account associated with a single payment card, a reply 124 to the response message 122 may be sent to the issuer server 104 to indicate the amount to be allocated for the second one of the plurality of credit limits to the single payment card. In various embodiments, the reply 124 to the response message 122 allows the payer/customer, via the payer device 102, to determine the amount to be allocated for the second one of the plurality of credit limits for the single payment card. In various embodiments, the reply 124 may be sent from the payer device 102 to the issuer server 104 when it is required that the payer/customer to determine the amount to be allocated for the second one of the plurality of credit limits to the single payment card. This may for example be used when the payer/customer wants to set credit limits for different categories of transactions associated with the single payment card. The reply 124 generated by the payer device 102 may be communicated to the payment network server 106 via the issuer server 104. In another embodiment, the reply 120 may be communicated directly to the payment network server 106 without communicating the request message 116 via the issuer server 104. In some embodiments, the reply 120 may be communicated by any means known to a person skilled in the art, for example wireless communications such as NFC, WIFI, Bluetooth, the public Internet or any other form of viable means of data communications.

In specific implementations, the payment network server 106 is further configured to perform additional operations. For example, the payment network server 106 may be configured to authenticate the request message 120 based on data relating to the payer account to determine if at least one of the plurality of credit limits is to be allocated. In other embodiments, the payment network server 106 is further configured to validate historical transaction data associated with the payer account to determine if a credit limit associated with a loan is to be allocated. In another example, the payment network server 106 is configured to determine if an amount in the payer account is at least equal to or more than a predetermined threshold value so as to determine if the payer account is associated with a high-profile or high-value payer. In various embodiments, the payer account is allowed to be allocated a plurality of credit limits if it is determined that the payer account is associated with a high-profile payer. In various embodiments, the payment network server 106 or the issuer server 104 may be further configured to determine and approve a predetermined credit limit associated with the insurance policy by using a set of predetermined rules given by the third party server 114.

Once, the single payment card associated with the payer account to be allocated with a plurality of credit limits have been approved and set-up, the plurality of credit limits associated with the single payment card may be used in effecting a transaction. In various embodiments, a transaction request 126 may be initiated by the payer/customer but generated at the payee device 110. For example, this may be the case when a payment card with a plurality of credit limits associated with the payer/customer is swiped at a Point-of-Sale (POS) terminal of a payee/merchant. In other embodiments, the transaction request 126 may also be initiated by the payer/customer at the payer device 102. This may for example be the case when the transaction request 126 may be initiated over a network like the Internet and the single payment card associated with the plurality of credit limits may be used via the payer device to initiate the transaction request 126. In an embodiment, the transaction request 126 comprises corresponding transaction data relating to a transaction which identifies the payer/customer and the payee/merchant, generally by way of identifiers each associated with the payer/customer and the payee/merchant respectively. In some embodiments, the transaction data comprises the name of the payer, the name of the payee, the names of a payer bank and a payee bank associated with the issuer server and the acquirer server respectively, and a payee bank account number. In some embodiments, the transaction data also comprise the payer bank's code and the payee bank's code which identify a bank, for example Indian Financial System Code (IFSC), Bank Identifier Number (BIN), Society for Worldwide Interbank Financial Telecommunication (SWIFT) code, and International Bank Account Number (IBAN). In some embodiments, the transaction data also identify the goods and/or services to be purchased and a type or nature of the transaction. In some embodiments, the transaction data further identify a value or price of the goods and/or services (e.g., a transaction amount). In some embodiments, the transaction data also indicate a time and a date at which the transaction was initiated by the payer.

The following types of transaction data may be included in the transaction request 126:
Transaction level information:
Payer ID (anonymized)
Payee ID
Name of Payer
Name of Payee
Name of Payer Bank
Name of Payee Bank
Transaction ID
Transaction Amount
Transaction Local Currency Amount
Date of Transaction
Time of Transaction
Type of Transaction
Date of Processing
Date to complete Transaction
Time to complete Transaction
Bank Codes (e.g. IFSC, BIN, SWIFT, IBAN etc)
Payee/Merchant Category Code (MCC)
Payment Card Type
Predetermined Range of Transaction Date
Predetermined Transaction Amount Range
Transaction Processing Code
Payer Account Type
Transaction Currency Code
Account (or Profile) Information:
Account ID (anonymized)
Payer Bank Account Number
Payee Bank Account Number
Total number of credit limits associated with the Payer Bank Account
Payee/Merchant Information:
Payee/Merchant ID
Payee/Merchant Name
MCC/Industry Code
Industry Description
Payee/Merchant Country
Payee/Merchant Address
Payee/Merchant Postal Code
Payee/Merchant Acquirer Country
Payee/Merchant Acquirer ID
Payee/Merchant Country Code
Issuer Information:
Issuer ID
Issuer Name
Issuer Country
Issuer Billing Currency

In various embodiments, the Transaction ID includes a category of transaction identifying the type of transaction. Examples of a category of transaction can be a medical transaction, a transport transaction, or a shopping transaction. In some embodiments, the Payee Category Code is associated with a category of payee. Examples of a category of payee may be a medical institution, an education institute, a department store, a transport facility or a restaurant. In some embodiments, the Payee Country Code corresponds to a country in which a payee of the transaction resides. In some embodiments, the Payment Card Type corresponds to the type of payment card used in the transaction. For example, a payment card type can be one of a credit card, a debit card, a pre-paid card, or a charge card. In various embodiments, the Predetermined Date and Transaction Amount Range corresponds to a range of date and a range of transaction amount identified by the payer account for each of the plurality of credit limits associated with the payer account. In embodiments, the Processing Code with the Payer Account Type corresponds to transaction processes associated with a type of payer account. In embodiments, the Transaction Currency Code corresponds to a type of currency used in the transaction. For example, the type of currency can be a type of foreign currency including US dollars, British Pounds, Indian Rupees, or Singapore dollars. In embodiments, the Billing Currency corresponds to a type of currency associated with the single payment card associated with the payer account used in the transaction. In various embodiments, the Total Number of Credit Limits identifies the total number of credit limits associated with the single payment card of the payer account.

In the preferred embodiment, the transaction request 126 may be sent by the payee device 110 to the issuer server 104 via the payment network 106 and the acquirer server 108. This may be done via the Internet through an appropriate website associated with the acquirer server 108. In another embodiment, the transaction request 126 may be sent to the issuer server 104 via only the payment network server 106, without having to communicate through the acquirer server 108. This may be done via the Internet through an appropriate website associated directly with the payment network server 106. In various embodiments, where the payer account is issued directly by the payment network server 106, the transaction request 126 may be sent to the payment network server 106. In various embodiments where the transaction request 126 is generated by the payee device 110, the transaction request 126 may be sent directly to the payment network server 106. In other embodiments, the transaction request 126 may be sent from the payee device 110 to the payment network server 106 via the acquirer server 108. In other embodiments where the transaction request 126 is generated by the payer device 102, the transaction request 126 may be sent directly to the payment network server 106. In other embodiments, the transaction request 126 may be sent from the payer device 102 to the payment network server 106 via the acquirer server 104. In other embodiments, the transaction request 126 may also be sent from the payer device 102 to the payment network 106 via the issuer server 104. In an embodiment, for example, where the transaction is being performed at the website of the payee/merchant, the payer device 102 and the payee/merchant device 110 are in communication with a network, such as, the Internet (not shown for the sake of simplicity). In an embodiment, the transaction request 122 is sent from the payer device 102 to the payment network server 106 directly via the network.

As mentioned above, the role of the payment network server 106 is to facilitate communication between the issuer server 104 and the acquirer server 108. Therefore, the payment network server 106 may serve as a means through which the acquirer server 108 may communicate with the issuer server 104 in a manner that payments and authentication may be performed. In specific implementations, the payment network server 106 may receive transaction data when initiating a transaction for a payer and subsequently store and/or update the transaction data in the database 112. In various embodiments, the database 112 may also include data related to the payer account and/or the payee account.

Additionally, the payment network server 106 may be configured to update the database 112 when initiating each transaction using at least one of the plurality of credit limits associated with the payer account. This helps to keep the transaction data relevant and updated. The payment network server 106 may also be configured to update the database 112 when a payer/customer or a payee/merchant registers an account at the payment network server 106 or when a payer/customer or a payee/merchant registers an account with a bank or a financial institution associated with an issuer server 104 or a bank or a financial institution associated with an acquirer server 108 respectively. In specific implementations, the database 112 provides historical transaction data to either the payment network server 106 or the issuer server 104 to determine if a credit limit for a loan is to be allocated for a payer account.

The processes to effect a transaction by using at least one of a plurality of credit limits associated with a payer account with a single payment card as described above involve multiple parties (e.g., payer/customer, payee/merchant, acquirer, issuer, payment facilitator). However, the transaction may essentially be viewed as a transaction between a payer and a payee (with the other parties facilitating the transaction).

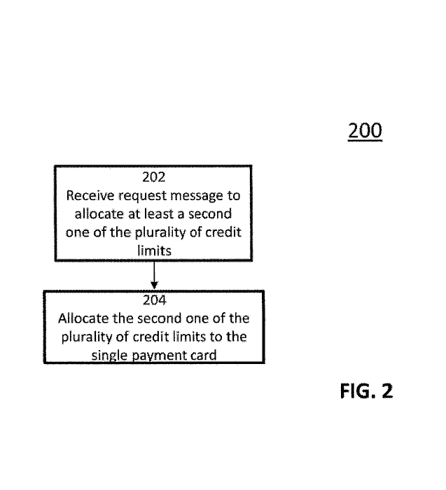

FIG. 2 shows a flow chart 200 illustrating a computer-implemented method for allocating at least one of a plurality of credit limits for a payer account associated with a single payment card for effecting a transaction in accordance with the first embodiment. In the embodiment, the payer account associated with the single payment card has been approved to be allocated with a plurality of credit limits as described using the enrolment request message 116 and the enrolment response message 118 in FIG. 1.

Referring to FIG. 2, at step 202, a request message 120 to allocate at least a second one of the plurality of credit limits for the payer account is received by the payment network server 106. In various embodiments, the request message 120 is generated by the payer device 102 associated with the payer account which is allowed to have a plurality of credit limits to be allocated. In various embodiments, the request message 120 includes data relating to the payer account. In various embodiments, each of the plurality of credit limits identifies a maximum payment amount that is authorised for payment to a category of transaction. In some embodiments, the category of transaction relates to the type of transactions which at least one of the plurality of credit limit may be authorised to make payment for. For example, the at least one of the plurality of credit limits may be associated with a housing loan. In this case, the credit limit associated with the housing loan may only be used to pay for transactions related to the property which the housing loan is issued for. In another example, the at least one of the plurality of credit limits may be associated with a medical insurance policy. In this case, the credit limit associated with the medical insurance policy may only be used for medical related expenses. In an embodiment, the request message 120 can be sent by the payer device 102 to the payment network server 106 via the issuer server 104. In another embodiment, the request message 120 can be sent by the payer device 102 to the payment network server 106 directly without communicating the request message 120 via the issuer server 104.

At step 204, the second one of the plurality of credit limits for the payer account associated with the single payment card is allocated. In some embodiments, the payer may be notified via the payer device 102 that the second one of the plurality of credit limits for the single payment card has been allocated. In various embodiments, this may be achieved via the response message 122, which may include a notification that the request message 120 has been processed and the second one of the plurality of credit limits has been allocated to the single payment card. In various embodiments, the request message 120 may also include the amount to be allocated for the second one of the plurality of credit limits. In an embodiment, the response message 122 is generated by the payment network server 106. In an embodiment, the response message 122 can be sent by the payment network server 106 to the payer device 102 via the issuer server 104. In another embodiment, the response message 122 generated by the payment network server 106 can be sent to the payer device 102 directly without communicating the response message 122 via the issuer server 104. In other embodiments, the response message 122 may be generated by the issuer server 104. In this case, the response message 122 may be sent to the payer device 102 by the issuer server 104.

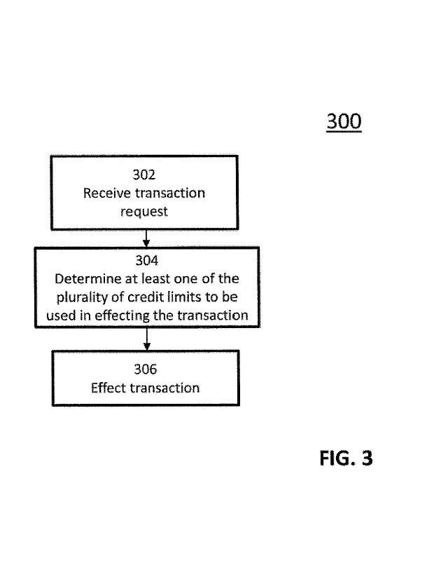

Referring to FIG. 3, a flow chart 300 of steps in the method of effecting a transaction based on the method of allocating at least a second one of a plurality of credit limits for a payer account associated with a single payment card in accordance with the first embodiment is depicted. The method of effecting the transaction comprises the steps of receiving a transaction request, determining at least one of the plurality of credit limits to be used in effecting the transaction based on the category of transaction, and effecting the transaction.

At step 302, a transaction request 126 is received. In the preferred embodiment, the transaction request 126 corresponds to a transaction involving a payer account associated with a plurality of credit limits. The transaction request 126 may be generated by the payer device 102 or the payee device 110 to be sent to the issuer server 104. In various embodiments, the transaction request 126 generated by the payer device 102 may be sent to the issuer server 104 directly. In other embodiments, the transaction request 126 generated by the payee device 110 may be sent to the issuer server 104 via the payment network server 106 and the acquirer server 108, or may be sent to the issuer server 104 via only the payment network server 106. In other embodiments where the payer account is issued directly by the payment network server 106, the transaction request 126 generated by either the payer device 102 or the payee device 110 may be sent to the payment network server 106. In various embodiments, the transaction request 126 generated by either the payer device 102 or the payee device 110 may be sent to the payment network server 106 directly, or via the issuer server 104 or the acquirer server 108, respectively. In various embodiments, the transaction request 126 will include information related to the transaction, the payer, the issuer, the payee and the acquirer as discussed above. In some embodiments, the transaction request also includes a category of transaction and a transaction amount, the transaction amount being an amount to be paid by the payer account in the transaction. In various embodiments, the transaction request 126 further comprises the payee category code, the payee country code, the payment card type, the predetermined date or amount range, and the processing code with the payer account type. In other embodiments, the transaction request 126 comprises the payee country code, the transaction currency code, the billing currency and the total number of the plurality of credit limits In various embodiments, the information associated with the transaction request 126 is then used to determine at least one of the plurality of credit limits to be used in effecting the transaction. In some embodiments, the transaction request 126 may be communicated by any means known to a person skilled in the art, for example wireless communications such as NFC, WIFI, Bluetooth, the public Internet (whether connected via a wireless or wired interface), or any other form of viable means of data communications. Alternatively, RFID and infra-red technology may also be used.

At step 304, the payment network server 106 is configured to determine at least one of the plurality of credit limits associated with the payer account to be used in effecting the transaction based on at least a category of transaction. In various embodiments, the category of transaction includes one of the following: a medical-related transaction, a transport-related transaction, a housing-related transaction, a retail transaction, a food and beverages related transaction and a general purchase transaction. In various embodiments, depending on the category of transaction associated with the transaction request 126, the payment network server 106 may then determine at least one of the plurality of credit limits associated with the payer account to be used in effecting the transaction.

Based on the results of step 304, the payment network server 106 is configured to effect the transaction using the at least one of the plurality of credit limits determined to effect the transaction in step 306. In some embodiments, the payment network server 106 is further configured to send a message to the payer via the payer device 102 when effecting the transaction. In embodiments, the message to the payer may include the at least one of the plurality of credit limits used in effecting the transaction and the transaction amount.

FIG. 4, comprising FIG. 4A, FIG. 4B, FIG. 4C and FIG. 4D, depicts additional steps in the method for allocating at least a second one of a plurality of credit limits for a payer account associated with a single payment card in accordance with other embodiments, where FIG. 4A depicts the step of 204 of FIG. 2 further comprising authenticating the request message 120, and allocating the second one of the plurality of credit limits to the single payment card; FIG. 4B depicts the step of 202 of FIG. 2 further comprising sending a response message 122 which includes a request for an amount to be allocated for the second one of the plurality of credit limits, and receiving a reply 124 to the response message 122 indicating the amount to be allocated for the second one of the plurality of credit limits; FIG. 4C depicts the step of 202 of FIG. 2 further comprising validating historical transaction data, and the step of 204 of FIG. 2 further comprising receiving the at least a second one of the plurality of credit limits to be allocated and allocating the second one of the plurality of credit limits to the single payment card; and FIG. 4D depicts the step of 202 of FIG. 2 further comprising sending a request message to a third party server 114, and the step of 204 of FIG. 2 further comprising receiving the at least a second one of the plurality of credit limits to be allocated and allocating the second one of the plurality of credit limits to the single payment card. The purpose of FIG. 4 is to illustrate different embodiments for allocating the at least a second one of the plurality of credit limits for the payer account associated with the single payment card. Whereas in the method depicted by the flowchart in FIG. 2 which describes that the second one of the plurality of credit limits is allocated in step 204 upon receiving a request message 120 in step 202, FIG. 4A describes an embodiment where the step of allocating the second one of the plurality of credit limits to the single payment card further comprises in step 204A, authenticating the request message 120 based on the data relating to the payer account to determine if the at least a second one of the plurality of credit limits is to be allocated. In various embodiments, the authentication of the request message 120 may be implemented by the issuer server 104 or the payment network server 106. In various embodiments, the authentication of the request message 120 includes determining if the request message 120 is initiated by the payer of the payer account and determining if the payer account associated with the request message 120 is authorised to be allocated a plurality of credit limits. In various embodiments, if the authentication of the request message 120 is successful, the second one of the plurality of credit limits is allocated to the single payment card in step 204B. In the event that the authentication of the request message 120 is unsuccessful, a failure message may be sent to the payer device 102 to notify the payer that the request to allocate the second one of the plurality of credit limits to the single payment card is unsuccessful.

FIG. 4B describes another embodiment for allocating at least a second one of the plurality of credit limits for a payer account associated with a single payment card. In this embodiment, the step of 202 in FIG. 2 further comprises the step 202A of sending, to a payer device 102, a response message 122 to the request message 120 to allocate at least a second one of the plurality of credit limits for the payer account where the response message 122 includes a request for an amount to be allocated for the second one of the plurality of credit limits, and the step 202B of receiving a reply 124 to the response message 122 where the reply 124 indicates the amount to be allocated for the second one of the plurality of credit limits to the single payment card. The purpose of this embodiment is to allow the payer/customer of the payer account to be allocated a plurality of credit limits to set an amount for at least a second one of the plurality of credit limits to be allocated to the single payment card. This advantageously allows the payer of the authorised payer account to determine the amount for the credit limit to be allocated so that the payer may plan his or her budget for each category of transaction for his or her needs. In various embodiments, the response message 122 in step 202A may be generated and sent to the payer device 102 by the issuer server 104. In other embodiments, the response message 122 in step 202A may also be generated and sent to the payer device 102 by the payment network server 106. After receiving the response message 122 in step 202A, the payer may be prompted to include an amount for the credit limit to be allocated in a reply 124 to the response message 122. The reply 124 may be generated by the payer through the payer device 102 and it can be sent to either the issuer server 104 or the payment network server 106 in step 202B, depending on whether the payer account is issued by the issuer server 104 or the payment network server 106, respectively.

FIG. 4C describes another embodiment for allocating at least a second one of the plurality of credit limits for a payer account associated with a single payment card. In this embodiment, the step 202 of FIG. 2 further comprises the step 202C of validating historical transaction data associated with the payer account to determine if the at least a second one of the plurality of credit limits is to be allocated; and the step 204 of FIG. 2 further comprises the step 204D of receiving an amount to be allocated for the second one of the plurality of credit limits if it is determined that the second one of the plurality of credit limits is to be allocated, and the step 204B of allocating the second of one of the plurality of credit limits to the single payment card. In various embodiments, the historical transaction data include information relating to transactions that have been completed using the payer account. The purpose of this embodiment is to describe allocation of at least a second one of the plurality of credit limits related to a loan. In various embodiments, the second one of the plurality of credit limits may be associated with a loan. In various embodiments, the loan may be a personal loan, a vehicle loan, a housing loan, or a study loan. In various embodiments, the loan may be issued by the issuer associated with the issuer server 104. In other embodiments, the loan may be issued by the payment network associated with the payment network server 106. In various embodiments, the issuer server 104 or the payment network server 106 is further configured to validate the historical transaction data associated with the payer account and to determine the amount to be allocated for the second one of the plurality of credit limits. In various embodiments, a credit limit may have already been allocated to the single payment card associated with the payer account so that the second one of the plurality of credit limits to be allocated is an additional credit limit. In this embodiments, the second one of the plurality of credit limits is associated with the loan. In various embodiments, the credit limit for the loan can only be used for specific transactions related to the loan. For example, a credit limit associated with a study loan may only be used for transactions related to education such as a transaction to buy books or stationary or to pay school fees.

FIG. 4D describes another embodiment for allocating at least a second one of the plurality of credit limits for a payer account associated with a single payment card. In this embodiment, the step 202 of FIG. 2 further comprises the step 202C of sending, to a third party server 114, the request message 120, the third party server 114 being a server which determines if the at least a second one of the plurality of credit limits is to be allocated; and the step 204 of FIG. 2 further comprises the step 204D of receiving an amount to be allocated for the second one of the plurality of credit limits if it is determined that the second one of the plurality of credit limits is to be allocated, and the step 204B of allocating the second of one of the plurality of credit limits to the single payment card. In various embodiments, the third party server 114 is associated with an insurance company or an institution which administers insurance policies. In the preferred embodiment, the request message 120 received by the payment network server 106 is sent to the third party server 114 to determine if the second one of the plurality of credit limits is to be allocated. For example, the appropriate information associated with the payer corresponding to the payer account may be sent to the insurance company associated with the third party server 114 where the third party server 114 may validate the information provided and subsequently initiate an insurance policy as requested by the payer/customer. In various embodiments, once the third party server 114 receives the request message 120, the third party server 114 will determine if the second one of the plurality of credit limits is to be allocated based on the information included in the request message 120. The information used may include data associated with the payer account. In step 204D, once it is determined that the second one of the plurality of credit limits is to be allocated, the third party server 114 will send an amount to be allocated for the second one of the credit limits to the payment network server 106. The payment network server 106 will subsequently allocate the second one of the plurality of credit limits to the single payment card in step 204B. For example, the insurance company may update the issuer server 104 or the payment network server 106 via the third party server 114 on the amount to be allocated for the second one of the plurality of credit limits that is associated with the insurance policy. In other embodiments, if the payer account is issued by the issuer server 104, the payment network server 106 may also forward the amount to be allocated for the second one of the credit limits to the issuer server 104, where the issuer server 104 will allocate the second one of the plurality credit limits to the single payment card. In some embodiments, the payment network server 106 or the issuer server 104 may be given a set of predetermined rules by the third party server 114 which may be used to approve the second one of the plurality of credit limits that is associated with the insurance policy. In various embodiments, the amount to be allocated to the second one of the plurality of credit limits associated with the insurance policy may also be predetermined. This may for example be applied to credit limits associated with standard travel and car insurance policies. In various embodiments, the second one of the plurality of credit limits may be a credit limit associated with a medical insurance policy, or a car insurance policy, or any other types of insurance policies. For example, a credit limit associated with a medical insurance policy may correspond to the maximum claim limit of the medical insurance policy. Moreover, the credit limit associated with the medical insurance policy may also only be used in transactions related to medical use, such as a visit to a doctor, or payment for medications etc.

Referring to FIG. 5, comprising FIG. 5A and FIG. 5B, additional steps in the method of using at least one of a plurality of credit limits for a payer account associated with a single payment card for effecting a transaction in accordance with other embodiments are depicted. The purpose of FIG. 5 is to describe embodiments for determining the at least one of the plurality of credit limits associated with the payer account to be used for effecting a transaction. In particular, FIG. 5A depicts a flow chart including the steps of determining the at least one of the plurality of credit limits associated with the payer account to be used for effecting a transaction for different types of services, while FIG. 5B depicts a flow chart including the steps of determining the at least one of the plurality of credit limits associated with the payer account to be used for effecting a transaction for different types of currencies.

FIG. 5A depicts the step of 304 of FIG. 3 further comprising the step 304A of determining at least one of the plurality of credit limits to be used based on any one of the following: payer category code, payee country code, payment card type, pre-determined date or transaction amount range, and processing code associated with payer account type; and step 304B of determining the at least one of the plurality of credit limits to be used in effecting the transaction. In various embodiments, the payment network server 106 is configured to determine the at least one of the plurality of credit limits to be used in effecting the transaction based on at least one of the following: a payee category code, a payee country code, a payment card type, a predetermined date or amount range, and a processing code with the payer account type. In some embodiments, the Payee Category Code is associated with a category of payee/merchant. In some embodiments, the Payee Country Code corresponds to a country in which a payee/merchant of the transaction resides. In some embodiments, the Payment Card Type corresponds to the type of payment card used in the transaction. For example, a payment card type can be one of a credit card, a debit card, a pre-paid card, and a charge card. In embodiments, the Predetermined Date and Transaction Amount Range corresponds to a range of dates and a range of transaction amounts identified by the payer account for each of the plurality of credit limits associated with the payer account. In embodiments, the Processing Code with the Payer Account Type corresponds to transaction processes associated with a type of payer account. For example, a type of payer account may be a payer account to be allocated with a plurality of credit limits. In various embodiments, based on the parameters which accompany the transaction request 126, the payment network server 106 determines the at least one of the plurality of credit limits to be used in effecting the transaction. For example, the parameters may be considered by the payment network server 106 in determining the at least one of the plurality of credit limits to be used in effecting the transaction on top of the category of transaction comprised in the transaction request 126. In various embodiments, the at least one of the plurality of credit limits to be used in effecting the transaction may be categorized into a normal credit limit, an insurance credit limit or a loan credit limit. Examples of a normal credit limit is a credit limit associated with a credit card, a debit card, a charge card or a credit facility linked to the payer account. In other embodiments, the insurance credit limit is a credit limit associated with an insurance policy. Examples of an insurance policy are a medical insurance policy, a housing insurance policy and a car insurance policy. In yet other embodiments, the loan credit limit is a credit limit associated with a loan. The loan may be issued by either the issuer or the payment network. Examples of a loan are a personal loan, a housing loan and a car loan. In various embodiments, the amount of the transaction may be deducted from the credit limit associated with a loan. The amount of the transaction deducted from the credit limit associated with the loan may then be repaid by the payer/customer by equated monthly instalment (EMI) to the payer account on a monthly basis.

FIG. 5B depicts the step of 304 of FIG. 3 further comprising the step 304C of determining at least one of the plurality of credit limits to be used based on any one of the following: payee country code, transaction currency code, a billing currency and a total number of the plurality of credit limits, and the step 304B of determining the at least one of the plurality of credit limits to be used in effecting the transaction. In various embodiments, the payment network server 106 is configured to determine the at least one of the plurality of credit limits to be used in effecting the transaction based on at least one of the following: a payee country code, a transaction currency code, a billing currency and a total number of the plurality of credit limits. In various embodiments, the at least one of the plurality of credit limits to be used in effecting the transaction is associated with a type of currency. In embodiments, the Transaction Currency Code corresponds to a type of currency used in the transaction. For example, the type of currency can be a type of foreign currency including US dollars, British Pounds, Indian Rupees, or Singapore dollars. In embodiments, the Billing Currency corresponds to a type of currency associated with the payer account. In embodiments, the Total Number of Credit Limits identifies the total number of credit limits associated with the payer account. The purpose of FIG. 5B is to describe a method for effecting a transaction using at least one of the plurality of credit limits, wherein the at least one of the plurality of credit limits is associated with a type of currency that is different from that associated with another one of the plurality of credit limits. In other words, FIG. 5B describes a method for effecting a transaction using at least one of the plurality of credit limits associated a type of currency. In various embodiments, the payer/customer can opt for the payer account to be associated with multiple types of currency using the same single payment card. In other words, the single payment card associated with the payer account to be allocated a plurality of credit limits can be used for credit limits associated with multiple services as described in FIG. 5A and used for credit limits associated with multiple types of currency at the same time. In various, embodiments, the payer/customer will be required by the issuer server 104 or the payment network server 106 to identify the payer's/customer's default type of currency when an enrolment request message 116 is first sent by the payer/customer via the payer device 102 to the issuer server 104 or the payment network server 106 to allow the payer account to be allocated a plurality of credit limits. In various embodiments, when the issuer server 104 or the payment network server 106 receives the transaction request 126, the issuer server 104 or the payment network server 106 will determine the at least one of the plurality of credit limits to be used based on at least one of the following parameters associated with the transaction: payee country code, transaction currency code, a billing currency and a total number of the plurality of credit limits. In various embodiments, the issuer server 104 or the payment network server 106 may determine the at least one of the plurality of credit limits based on all of the four parameters listed above. In various embodiments, there is no conversion charges of the different type of currencies for the transaction. As such, the payer/customer may benefit from no conversion rate charges for transactions involving a type of currency which may be different from the default currency associated with payer account but corresponds to one of the plurality of credit limits associated with the payer account. In various embodiments, the transaction request may be associated with a type of currency that has no corresponding credit limit for the type of currency which is associated with the payer account. In this case, the issuer server 104 or the payment network server 106 may effect the transaction based on the default type of currency which was set up for the payer account. In various embodiments, a transaction statement for transactions made in different types of currency may be generated at the end of each predetermined period of time for the payer account associated with credit limits corresponding to multiple types of currency. This advantageously consolidates all transactions related to different types of currency in a single transaction statement and allows effective management of these transactions by the payer/customer. The payer/customer may then choose to pay the issuer or the payment network in the individual types of currency that the transactions have been made during the predetermined period of time, or to pay for all the transactions made during the predetermined period of time using a single preferred currency. In various embodiments where the payer/customer choose to pay for all the transaction made during the predetermined period of time using a single preferred currency, a conversion rate may apply. In a preferred embodiment, the predetermined period of time may be one month.

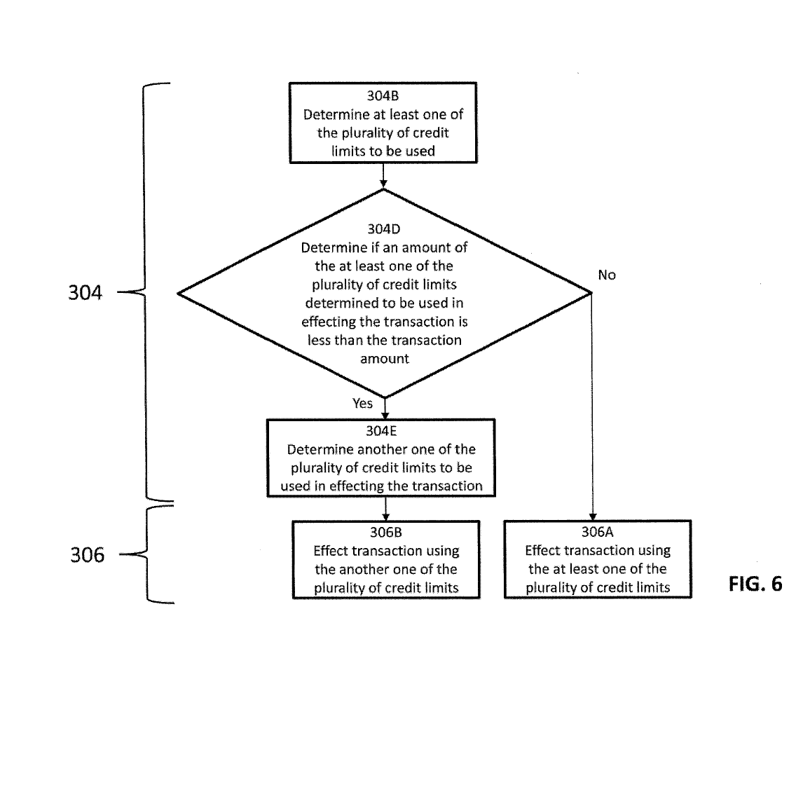

FIG. 6 depicts a flow chart of additional steps in the method of using at least one of a plurality of credit limits for a payer account associated with a single payment card for effecting a transaction in accordance with another embodiment, wherein the step 304 of FIG. 3 further comprises the step 304B of determining at least one of the plurality of credit limits to be used, the step 304D of determining if an amount of the at least one of the plurality of credit limits determined to be used in effecting the transaction is less than the transaction amount, and the step 304E of determining another one of the plurality of credit limits to be used in effecting the transaction if it is determined that the amount of the at least one of the plurality of credit limits is less than the transaction amount, and the step 306B of FIG. 3 in effecting the transaction using the another one of the plurality of credit limits. In various embodiments, if it is determined that the amount of the at least one of the plurality of credit limits is equal or more than the transaction amount, the transaction may be effected using the at least one of the plurality of credit limits in the step of 306A. In various embodiments, the step 304E further comprises the step of assigning the at least another one of the plurality of credit limits to be used in effecting the transaction to a predetermined credit limit, the predetermined credit limit being at least one of the plurality of credit limits identified by the payer account. In various embodiments, the step 304E further comprises the steps of determining a differential amount of the transaction where the differential amount of the transaction being an amount that corresponds to the difference between the amount of the at least one of the plurality of credit limits determined to be used in effecting the transaction and the transaction amount, and determining the at least another one of the plurality of credit limits to be used in effecting the transaction to pay for the differential amount of the transaction. The above embodiments may be illustrated by the following example. In various embodiments, a transaction request 126 may be related to a category of transaction associated with a medical insurance policy. In this case, the transaction request 126 generated by the payee device 110 may be sent to the issuer server 104, which may then be approved by the issuer server 104 associated with an issuer in real time before getting confirmation from the third party server 114 associated with the insurance company. The issuer server 104 may approved the transaction request 126 and determine at least one of the plurality of credit limits associated with an insurance policy to be used in effecting the transaction based on a set of initial guidelines agreed between the issuer and the insurance company. In various embodiments, the payer/customer will then submit all related medical reports to the insurance company after a predetermined post-transaction period. In various embodiments, the predetermined post-transaction period may be two weeks. The insurance company may then update the issuer about a percentage contribution of the transaction amount which may be charged to the credit limit associated with the medical insurance policy. The remainder of the transaction amount which is not charged to the credit limit associated with the medical insurance policy may then be charged to the payer/customer account using another of the plurality of credit limits associated with the payer/customer account. The above process advantageously minimizes the resources and time spend by the payer/customer to follow up on the administration of claiming the payment. In an embodiment, the another of the plurality of credit limits may be one of the normal credit limits as discussed above. In various embodiments, when the appropriate credit limit associated with the single payment card is fully utilized, the issuer server 104 may send a notification message to the payer device 102 to notify the payer/customer to pay the excess amount within a predetermined time period as emergency payment to make sure that the payer account associated with the issuer is not over-drafted. In other embodiments, if the payer account is issued by the payment network server 106, the payment network server 106 may send a notification message to the payer device 102 to notify the payer/customer to pay the excess amount within a predetermined time period as emergency payment to make sure that the payer account associated with the issuer is not over-drafted. In other words, the payer/customer is required to pay the excess amount so that the appropriate credit limits are not exceeded. In various embodiments, the appropriate credit limit may be one of the normal credit limits described previously. In various embodiments, the predetermined time period to pay the excess amount may be one month. In various embodiments, the transactions of all the plurality of credit limits associated with the single payment card of the payer account may be consolidated into a monthly transaction statement. This advantageously allows the payer/customer to manage all of the plurality of credit limits associated with different services and/or different types of currency in a consolidated manner, and enables the payer/customer to keep track of the amount of each of the plurality of credit limits which was used during the month.

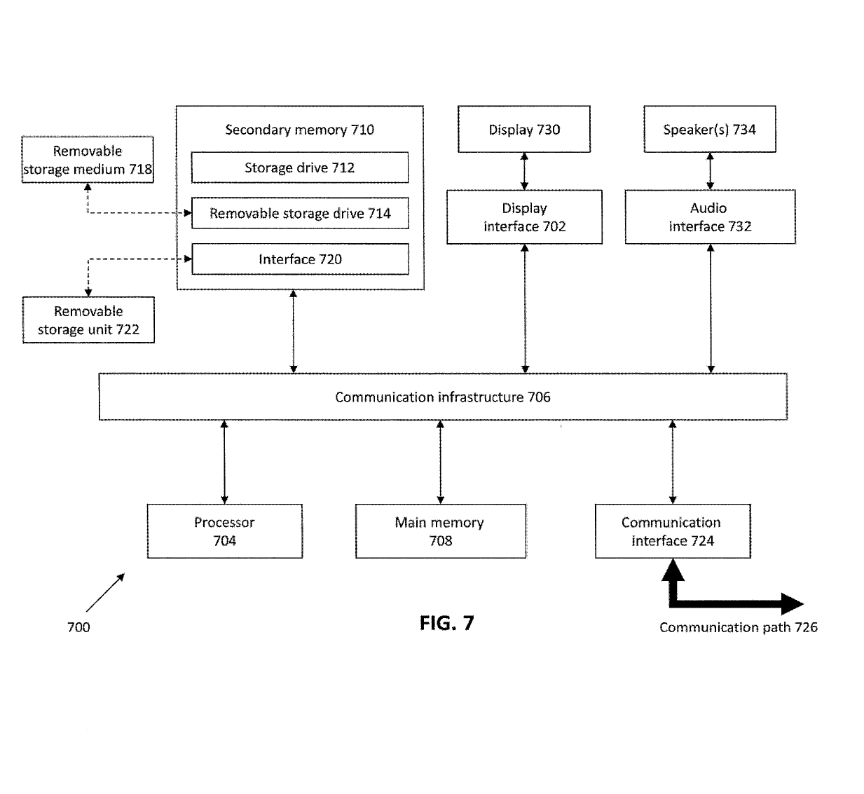

FIG. 7 depicts an exemplary computer/computing device 700, hereinafter interchangeably referred to as a computer system 700, where one or more such computing devices 700 may be used to facilitate execution of the above-described method for allocating a plurality of credit limits associated with a payer account and effecting a transaction using at least one of the plurality of credit limits. In addition, one or more components of the computer system 700 may be used to realize a computer. The following description of the computing device 700 is provided by way of example only and is not intended to be limiting.

As shown in FIG. 7, the example computing device 700 includes a processor 704 for executing software routines. Although a single processor is shown for the sake of clarity, the computing device 700 may also include a multi-processor system. The processor 704 is connected to a communication infrastructure 706 for communication with other components of the computing device 700. The communication infrastructure 706 may include, for example, a communications bus, cross-bar, or network.

The computing device 700 further includes a main memory 708, such as a random access memory (RAM), and a secondary memory 710. The secondary memory 710 may include, for example, a storage drive 712, which may be a hard disk drive, a solid state drive or a hybrid drive and/or a removable storage drive 714, which may include a magnetic tape drive, an optical disk drive, a solid state storage drive (such as a USB flash drive, a flash memory device, a solid state drive or a memory card), or the like. The removable storage drive 714 reads from and/or writes to a removable storage medium 718 in a well-known manner. The removable storage medium 718 may include magnetic tape, optical disk, non-volatile memory storage medium, or the like, which is read by and written to by removable storage drive 714. As will be appreciated by persons skilled in the relevant art(s), the removable storage medium 718 includes a computer readable storage medium having stored therein computer executable program code instructions and/or data.

In an alternative implementation, the secondary memory 710 may additionally or alternatively include other similar means for allowing computer programs or other instructions to be loaded into the computing device 700. Such means can include, for example, a removable storage unit 722 and an interface 720. Examples of a removable storage unit 722 and interface 720 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 722 and interfaces 720 which allow software and data to be transferred from the removable storage unit 722 to the computer system 700.

The computing device 700 also includes at least one communication interface 724. The communication interface 724 allows software and data to be transferred between computing device 700 and external devices via a communication path 726. In various embodiments of the inventions, the communication interface 724 permits data to be transferred between the computing device 700 and a data communication network, such as a public data or private data communication network. The communication interface 724 may be used to exchange data between different computing devices 700 which such computing devices 700 form part of an interconnected computer network. Examples of a communication interface 724 can include a modem, a network interface (such as an Ethernet card), a communication port (such as a serial, parallel, printer, GPIB, IEEE 1394, RJ25, USB), an antenna with associated circuitry and the like. The communication interface 724 may be wired or may be wireless. Software and data transferred via the communication interface 724 are in the form of signals which can be electronic, electromagnetic, optical or other signals capable of being received by communication interface 724. These signals are provided to the communication interface via the communication path 726.

As shown in FIG. 7, the computing device 700 further includes a display interface 702 which performs operations for rendering images to an associated display 730 and an audio interface 732 for performing operations for playing audio content via associated speaker(s) 734.

As used herein, the term “computer program product” may refer, in part, to removable storage medium 718, removable storage unit 722, a hard disk installed in storage drive 712, or a carrier wave carrying software over communication path 726 (wireless link or cable) to communication interface 724. Computer readable storage media refers to any non-transitory, non-volatile tangible storage medium that provides recorded instructions and/or data to the computing device 700 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 700. Examples of transitory or non-tangible computer readable transmission media that may also participate in the provision of software, application programs, instructions and/or data to the computing device 700 include radio or infra-red transmission channels as well as a network connection to another computer or networked device, and the Internet or Intranets including e-mail transmissions and information recorded on Websites and the like.

The computer programs (also called computer program code) are stored in main memory 708 and/or secondary memory 710. Computer programs can also be received via the communication interface 724. Such computer programs, when executed, enable the computing device 700 to perform one or more features of embodiments discussed herein. In various embodiments, the computer programs, when executed, enable the processor 704 to perform features of the above-described embodiments. Accordingly, such computer programs represent controllers of the computer system 700.

Software may be stored in a computer program product and loaded into the computing device 700 using the removable storage drive 714, the storage drive 712, or the interface 720. Alternatively, the computer program product may be downloaded to the computer system 700 over the communications path 726. The software, when executed by the processor 704, causes the computing device 700 to perform functions of embodiments described herein.

It is to be understood that the embodiment of FIG. 7 is presented merely by way of example. Therefore, in some embodiments one or more features of the computing device 700 may be omitted. Also, in some embodiments, one or more features of the computing device 700 may be combined together. Additionally, in some embodiments, one or more features of the computing device 700 may be split into one or more component parts.

In an implementation, the payment network server 106 may be generally described as a physical device comprising at least one processor 802 and at least one memory 704 including computer program code. The at least one memory 804 and the computer program code are configured to, with the at least one processor 802, cause the physical device to perform the operations described in FIGS. 2 to 6. An example of the payment network server 106 is shown in FIG. 8.

For example, the method of FIGS. 2 to 6 may be implemented as software and stored in a non-transitory fashion in the secondary memory 710 or the removable storage drive 714 of the computer device 700.

It will be appreciated by a person skilled in the art that numerous variations and/or modifications may be made to the present invention as shown in the specific embodiments without departing from the spirit or scope of the invention as broadly described. For example, the above description mainly discusses the use of a Bluetooth connection, but it will be appreciated that another type of secure wireless connection, such as Wi-Fi, can be used in alternate embodiments to implement the method. Some modifications, e.g. adding an access point, changing the log-in routine, etc. may be considered and incorporated. The present embodiments are, therefore, to be considered in all respects to be illustrative and not restrictive.

What is claimed is:

1. A computer-implemented method for allocating a plurality of credit limits for a payer account associated with a single payment card, the method comprising:
receiving, at a server, a request message to allocate at least a second one of the plurality of credit limits for the payer account, each of the plurality of credit limits being a maximum payment amount that is authorized for payment to a category of transaction; and
allocating the second one of the plurality of credit limits to the single payment card.

2. The method of claim 1, wherein allocating the second one of the plurality of credit limits comprises authenticating, at the server, the request message based on payer account data transmitted with the request message to determine if the at least a second one of the plurality of credit limits is to be allocated.

3. The method of claim 1, wherein receiving, at the server, the request message to allocate the at least a second one of the plurality of credit limits for the payer account comprises:
sending, to a payer device, a response message to the request message to allocate at least the second one of the plurality of credit limits for the payer account, the response message requesting an amount to be allocated for the second one of the plurality of credit limits;
receiving, at the server, a reply to the response message, the reply indicating the amount to be allocated for the second one of the plurality of credit limits; and
validating, at the server, historical transaction data associated with the payer account to determine if the at least a second one of the plurality of credit limits is to be allocated, the historical transaction data being information relating to transactions that have been completed using the payer account; and
wherein allocating the second one of the plurality of credit limits comprises receiving, at the server, an amount to be allocated for the second one of the plurality of credit limits if it is determined that the second one of the plurality of credit limits is to be allocated.

4. (canceled)

5. The method of claim 1, wherein receiving, at the server, the request message to allocate the at least a second one of the plurality of credit limits for the payer account comprises sending, to a third party server, the request message, the third party server being a server which determines if the at least a second one of the plurality of credit limits is to be allocated; and
wherein allocating the second one of the plurality of credit limits comprises receiving, at the server, an amount to be allocated for the second one of the plurality of credit limits if the third party server determines that the second one of the plurality of credit limits is to be allocated.

6. The method of claim 2, wherein authenticating, at the server, the request message based on the data to determine if the at least a second one of the plurality of credit limits is to be allocated further comprises determining, at the server, if an amount in the payer account is at least equal to or more than a predetermined threshold value; and
wherein allocating the second one of the plurality of credit limits further comprises allocating the second one of the plurality of credit limits when it is determined that the amount in the payer account is equal to or more than the predetermined threshold value.

7. The method of claim 1, further comprising:
receiving, at the server, a transaction request, the transaction request including the category of transaction and a transaction amount, the transaction amount being an amount to be paid by the payer account in the transaction;
determining, at the server, at least one of the plurality of credit limits to be used in effecting the transaction based on the category of transaction; and
effecting, at the server, the transaction.

8. The method of claim 7, wherein determining, at the server, the at least one of the plurality of credit limits to be used in effecting the transaction based on the category of transaction further comprises:
determining, at the server, if an amount of the at least one of the plurality of credit limits determined to be used in effecting the transaction is less than the transaction amount; and
determining, at the server, at least another one of the plurality of credit limits to be used in effecting the transaction if it is determined that the amount of the at least one of the plurality of credit limits is less than the transaction amount.

9. The method of claim 8, wherein determining, at the server, the at least another one of the plurality of credit limits to be used in effecting the transaction if it is determined that the amount of the at least one of the plurality of credit limits is less than the transaction amount comprises assigning, at the server, the at least another one of the plurality of credit limits to be used in effecting the transaction to a predetermined credit limit, the predetermined credit limit being at least one of the plurality of credit limits identified by the payer account; and/or
wherein determining, at the server, the at least another one of the plurality of credit limits to be used in effecting the transaction if it is determined that the amount of the at least one of the plurality of credit limits is less than the transaction amount comprises:
determining, at the server, a differential amount of the transaction, the differential amount of the transaction being an amount that corresponds to the difference between the amount of the at least one of the plurality of credit limits determined to be used in effecting the transaction and the transaction amount; and
determining, at the server, the at least another one of the plurality of credit limits to be used in effecting the transaction to pay for the differential amount of the transaction.

10. (canceled)

11. The method of claim 7, wherein determining the at least one of the plurality of credit limits to be used in effecting the transaction comprises determining, at the server, the at least one of the plurality of credit limits to be used in effecting the transaction based on at least one of the following: a payee category code, a payee country code, a payment card type, a predetermined date or amount range, and a processing code with the payer account type;
wherein the transaction request further comprises the payee category code, the payee country code, the payment card type, the predetermined date or amount range, and the processing code with the payer account type; and
wherein the payee category code corresponds to a category of payee; the payee country code corresponds to a country in which a payee of the transaction is residing; the payment card type corresponds to a type of payment card; the predetermined date or amount range corresponds to a range of dates or transaction amounts identified by the payer account; and the processing code with the payer account type corresponds to transaction processes associated with a type of payer account.

12. The method of claim 7, wherein determining the at least one of the plurality of credit limits to be used in effecting the transaction comprises determining, at the server, the at least one of the plurality of credit limits to be used in effecting the transaction based on at least one of the following: a payee country code, a transaction currency code, a billing currency and a total number of the plurality of credit limits;
wherein the transaction request further comprises the payee country code, the transaction currency code, the billing currency and the total number of the plurality of credit limits; and
wherein the payee country code corresponds to a country in which a payee of the transaction is residing; the transaction currency code corresponds to a type of currency used in the transaction; the billing currency corresponds to a type of currency associated with the payer account; and the total number of the plurality of credit limits identified the total number of credit limits associated with the payer account.

13. The method of claim 7, wherein the at least one of the plurality of credit limits is associated with at least one of the following: a credit line, a debit line, an insurance, and a loan; or
wherein the at least one of the plurality of credit limits is associated with a type of currency that is different from that associated with another one of the plurality of credit limits.

14. (canceled)

15. An apparatus for allocating a plurality of credit limits for a payer account associated with a payment card, the apparatus comprising:
at least one processor; and
at least one memory including computer program code, which when executed by the at least one processor, cause the at least one processor to:
receive a request message to allocate at least a second one of the plurality of credit limits for the payer account, the request message including data relating to the payer account, each of the plurality of credit limits being a maximum payment amount that is authorized for payment to a category of transaction; and
allocate the second one of the plurality of credit limits.

16. The apparatus according to claim 15, wherein the computer program code, when executed by the at least one processor, further causes the at least one processor, in connection with receiving the request message to allocate the at least a second one of the plurality of credit limits for the payer account, to:
authenticate the request message based on the data to determine that the second one of the plurality of credit limits is to be allocated;
send, to a payer device, a response message to the request message to thereby allocate the second one of the plurality of credit limits, the response message requesting an amount to be allocated for the second one of the plurality of credit limits; and
receive a reply to the response message, the reply indicating the amount to be allocated for the second one of the plurality of credit limits.

17. (canceled)

18. The apparatus according to claim 15, wherein the computer program code, when executed by the at least one processor, further causes the at least one processor, in connection with receiving the request message to allocate the at least a second one of the plurality of credit limits for the payer account, to validate historical transaction data associated with the payer account to determine if the at least a second one of the plurality of credit limits is to be allocated, the historical transaction data being information relating to transactions that have been completed using the payer account; and
wherein the computer program code, when executed by the at least one processor, further causes the at least one processor, in connection with allocating the second one of the plurality of credit limits, to receive an amount to be allocated for the second one of the plurality of credit limits in response to a determination that the second one of the plurality of credit limits is to be allocated.

19. The apparatus according to claim 15, wherein the computer program code, when executed by the at least one processor, further causes the at least one processor, in connection with receiving the request message to allocate the at least a second one of the plurality of credit limits for the payer account, to send, to a third party server, the request message, the third party server being a server which determines if the at least a second one of the plurality of credit limits is to be allocated; and
wherein the computer program code, when executed by the at least one processor, further causes the at least one processor, in connection with allocating the second one of the plurality of credit limits, to receive an amount to be allocated for the second one of the plurality of credit limits in response to a determination by the third party server that the second one of the plurality of credit limits is to be allocated.

20. (canceled)

21. The apparatus of claim 15, wherein the computer program code, when executed by the at least one processor, further causes the at least one processor to:
receive a transaction request, the transaction request including the category of transaction and a transaction amount, the transaction amount being an amount to be paid by the payer account in the transaction;
determine at least one of the plurality of credit limits to be used in effecting the transaction based on the category of transaction; and
effect the transaction.

22. The apparatus according to claim 21, wherein the computer program code, when executed by the at least one processor, further causes the at least one processor, in connection with determining the at least one of the plurality of credit limits to be used in effecting the transaction based on the category of transaction, to:
determine if an amount of the at least one of the plurality of credit limits determined to be used in effecting the transaction is less than the transaction amount; and
determine at least another one of the plurality of credit limits to be used in effecting the transaction if it is determined that the amount of the at least one of the plurality of credit limits is less than the transaction amount.

23. The apparatus according to claim 22, wherein the computer program code, when executed by the at least one processor, further causes the at least one processor, in connection with determining the at least another one of the plurality of credit limits to be used in effecting the transaction if it is determined that the amount of the at least one of the plurality of credit limits is less than the transaction amount to:
determine a differential amount of the transaction, the differential amount of the transaction being an amount that corresponds to the difference between the amount of the at least one of the plurality of credit limits determined to be used in effecting the transaction and the transaction amount;
determine the at least another one of the plurality of credit limits to be used in effecting the transaction to pay for the differential amount of the transaction; and
assign the at least another one of the plurality of credit limits to be used in effecting the transaction to a predetermined credit limit, the predetermined credit limit being at least one of the plurality of credit limits identified by the payer account.

24. (canceled)

25. The apparatus according to claim 21, wherein the computer program code, when executed by the at least one processor, further causes the at least one processor, in connection with determining to the at least one of the plurality of credit limits to be used in effecting the transaction based on the category of transaction, to determine the at least one of the plurality of credit limits to be used in effecting the transaction based on at least one of the following: a payee category code, a payee country code, a payment card type, a predetermined date or amount range, and a processing code with the payer account type;
wherein the transaction request further comprises the payee category code, the payee country code, the payment card type, the predetermined date or amount range, and the processing code with the payer account type; and
wherein the payee category code corresponds to a category of payee; the payee country code corresponds to a country in which a payee of the transaction is residing; the payment card type corresponds to a type of payment card; the predetermined date or amount range corresponds to a range of dates or transaction amounts identified by the payer account; and the processing code with the payer account type corresponds to transaction processes associated with a type of payer account.

26. The apparatus according to claim 21, wherein the computer program code, when executed by the at least one processor, further causes the at least one processor, in connection with determining the at least one of the plurality of credit limits to be used in effecting the transaction based on the category of transaction, to determine the at least one of the plurality of credit limits to be used in effecting the transaction based on at least one of the following: a payee country code, a transaction currency code, a billing currency and a total number of the plurality of credit limits;
wherein the transaction request further comprises the payee country code, the transaction currency code, the billing currency and the total number of the plurality of credit limits; and
wherein the payee country code corresponds to a country in which a payee of the transaction is residing; the transaction currency code corresponds to a type of currency used in the transaction; the billing currency corresponds to a type of currency associated with the payer account; and the total number of the plurality of credit limits identified the total number of credit limits associated with the payer account.

27.-29. (canceled)
